(19) United States
(12) Patent Application Publication
(10) Pub. No.: US 2012/0009504 A1
(43) Pub. Date: Jan. 12, 2012

(54) ELECTRODES FOR FUEL CELLS

(75) Inventors: Shriram Ramanathan, Acton, MA (US); Alexander C. Johnson, Cambridge, MA (US)

(73) Assignee: PRESIDENT AND FELLOWS OF HARVARD COLLEGE, Cambridge, MA (US)

(21) Appl. No.: 13/145,342

(22) PCT Filed: Jan. 20, 2010
(86) PCT No.: PCT/US10/21543

§ 371 Date: Oct. 3, 2011

Related U.S. Application Data
(60) Provisional application No. 61/145,885, filed on Jan. 20, 2009.

(51) Int. Cl. H01M 4/86; H01M 8/02; B05D 5/12; B82Y 30/00

(52) U.S. Cl. 429/532; 427/115; 429/535; 977/773; 977/755

(57) ABSTRACT

A method comprises creating an electrode by depositing alternating first and second layers on a substrate, and using the electrode to make a solid oxide fuel cell. The first layer comprises a metal, and the second layer comprises a non-metal, for example a ceramic material. The substrate may be moved between a first region containing the metal and substantially free of the non-metal, and a second region containing the non-metal and substantially free of the metal. The composition of the metal and/or the non-metal may be varied along the thickness of the layers. The deposited layers may be heated. A fuel cell may have a fuel cell electrode that comprises a substrate, and alternating first and second layers deposited on the substrate, where the first layer includes a metal and the second layer includes a non-metal. The fuel cell may be a solid oxide fuel cell.

### CROSS-REFERENCE TO RELATED APPLICATIONS

The present application is based upon, and claims the benefit of priority under 35 U.S.C. §119, to co-pending U.S. Provisional Patent Application No. 61/145,885 (the “'885 provisional application”), filed Jan. 20, 2009 and entitled “Electrodes For Fuel Cells.” The content of the '885 provisional application is incorporated herein by reference in its entirety as though fully set forth.

### BACKGROUND

A fuel cell is a device that can convert chemical energy in a fuel into electrical energy by promoting a chemical reaction between two gases (e.g., hydrogen (fuel) and oxygen in air). A fuel cell typically includes a positive electrode (“an anode”), a negative electrode (“a cathode”), and an electrolyte that electronically separates the electrodes while allowing ions to pass to maintain charge balance. The material used for the electrolyte generally characterizes the fuel cell. For example, a fuel cell that includes a polymer electrolyte membrane (or a proton exchange membrane) as the electrolyte is called a PEM fuel cell. A fuel cell that includes a solid oxide electrolyte is called a solid oxide fuel cell (SOFC).

An SOFC typically includes two ceramic-containing electrodes that sandwich a solid oxide electrolyte. The anode and the cathode are porous to allow fuel or air to flow toward the electrolyte, and electronically conducting. The anode is also ionically conducting. An example of an anode material is a mixture including a metal (e.g., nickel) and a ceramic material (e.g., yttria stabilized zirconia). An example of a cathode material is lanthanum strontium manganite (La₁₋ₓSrₓMnO₃). The solid oxide electrolyte can include an oxygen ion conducting ceramic with low electronic conductivity, such as yttrium stabilized zirconia or gadolinium doped ceria. Multiple SOFCs can be connected in series using conductive interconnects to create a fuel cell stack that combines the electricity each SOFC generates.

During operation of an SOFC, typically at high temperatures (e.g., >500° C.), oxygen is introduced to and reduced at the cathode, and fuel is introduced to and oxidized at the anode. At the cathode, oxygen interacts with the electrode, acquires four electrons, and splits into two oxygen ions (O₂+4e−→2O²⁻). The oxygen ions diffuse through the electrolyte and migrate to the anode. At the anode, also called the fuel electrode, the oxygen ions react with the fuel (e.g., H₂) to form water and electrons (2H₂+20²⁻→2H₂O+4e−). The electrons flow through the anode to an external circuit, where they provide electrical energy, and back to the cathode. The above reduction-oxidation reactions are repeated to provide electrical energy.

### SUMMARY

In one aspect, the present disclosure describes a method of making a fuel cell electrode. The method includes depositing alternating first and second layers on a substrate, the first layer comprising a metal, and the second layer comprising a non-metal.

In another aspect, the present disclosure describes a method of making a solid oxide fuel cell. The method includes creating an electrode by depositing alternating first and second layers on a substrate, the first layer comprising a metal, and the second layer comprising a non-metal. The method further includes using the electrode to make the solid oxide fuel cell.

In another aspect, the present disclosure describes a fuel cell electrode. The fuel cell electrode comprises a substrate, and alternating first and second layers deposited on the substrate. The first layer comprises a metal, and the second layer comprises a non-metal.

In another aspect, the present disclosure describes a fuel cell that includes a fuel cell electrode. The fuel cell electrode includes alternating first and second layers deposited on a substrate. The first layer comprises a metal, and the second layer comprises a non-metal. In some embodiments, the fuel cell is a solid oxide fuel cell.

### BRIEF DESCRIPTION OF DRAWINGS

The drawing figures depict one or more implementations in accordance with the concepts disclosed herein, by way of example only, not by way of limitations. The drawings disclose illustrative embodiments. They do not set forth all embodiments. Other embodiments may be used in addition or instead.

FIG. 1 is a schematic diagram of a portion of an embodiment of a solid oxide fuel cell stack.

FIG. 2 is a schematic diagram of an embodiment of a method for making a fuel cell electrode.

FIG. 3 is a schematic diagram of an embodiment of a deposition system.

FIGS. 4A and 4B are schematic diagrams of embodiments of deposition masks.

FIG. 5 shows X-ray diffraction patterns of nickel/yttria stabilized zirconia films, as deposited and after one hour of annealing at 600° C. in a reducing atmosphere.

### DETAILED DESCRIPTION

The present disclosure relates to electrodes for fuel cells, fuel cells including but not limited to solid oxide fuel cells (SOFCs), and methods of making the same. All references, such as patents, patent applications, and publications, referred to in this section, are incorporated by reference in their entirety.

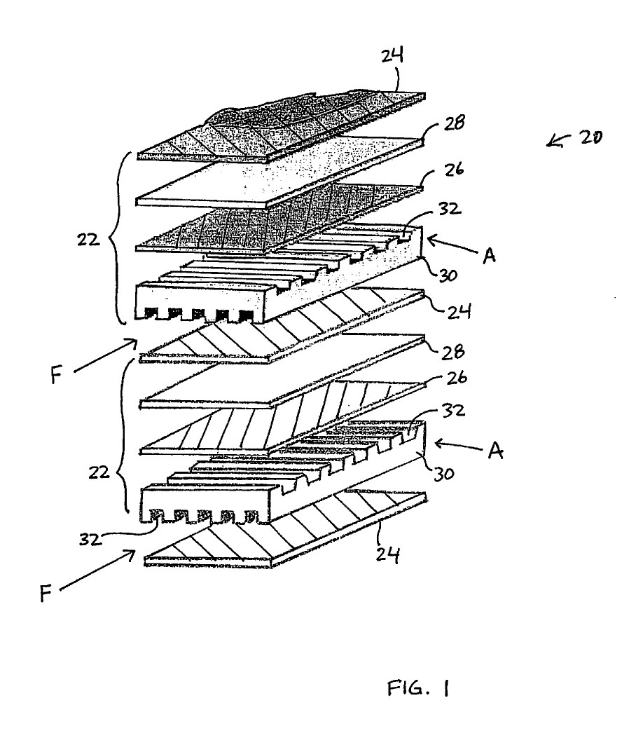

FIG. 1 shows a portion of a fuel cell stack 20 including a plurality of solid oxide fuel cells (SOFCs) 22 connected in series. Each fuel cell 22 includes an anode 24, a cathode 26, a solid oxide electrolyte 28 between the anode and the cathode, and an interconnect 30 that provides electrical contact between two juxtaposed fuel cells. As shown, interconnect 30 includes channels 32 on its opposing surfaces through which air is delivered to cathode 26 (arrow A) and a fuel is delivered to anode 24 (arrow F) during operation of stack 20.

Anode 24 includes (e.g., is formed solely or entirely of) a composite mixture containing a ceramic and a metal, sometimes called a cermet. As described below, cermets can be synthesized with a number of properties to perform well as fuel cell electrodes. For example, the cermets can maintain both the metal and the ceramic in selected phases with little or no mixed phase at the metal/ceramic interface, so that the metal is a good electronic conductor and the ceramic is a good oxide ion conductor. Both the metal and the ceramic form contiguous networks that facilitate long-range conduction. The feature size of both the metal and the ceramic can be kept small, and the cermets can be made porous to increase (e.g., maximize) the aggregate length of triple-phase boundaries in the cermet and to lower (e.g., minimize) area-specific resistance, for example, due to catalysis of the half reaction (e.g., H₂+O₂→H₂O+2e− at anode 24) that can occur where the metal, ceramic, and gas phases all come into contact.

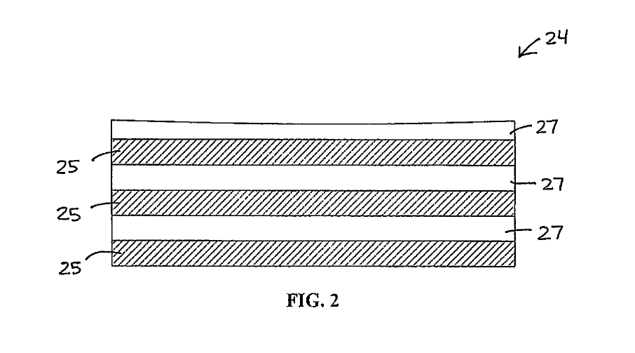

More specifically, cermets that can be used to construct anode 24 can be formed by depositing alternating layers including a metal (“metal layers”) and layers including a ceramic material (“ceramic layers”). Referring to FIG. 2, using physical vapor deposition (PVD), such as sputter deposition, and/or chemical vapor deposition (CVD), a first layer 25 (a metal layer or a ceramic layer) is deposited on a substrate until the layer is approximately 1 nm to approximately 500 nm thick. Then, a second layer 27 (a ceramic layer or a metal layer) different in composition from first layer 25 is similarly deposited on the first layer. The layers are alternated and repeatedly deposited until a structure is formed having a selected total thickness (e.g., at least 20 nm) and made of many thin metal and ceramic layers. For these thin layers, the metal and the ceramic material can segregate into grains of pure metal and ceramic material that are somewhat larger than the layer thickness. But the cermet has no layered structure and appears as a nearly isotropic mixture of discrete metal and ceramic grains. PVD and CVD are generally described, for example, in a book such as “Thin Film Deposition”.

The deposition techniques include a variety of conditions. For example, the deposition temperature can range from approximately 25° C. to approximately 600° C. The pressure in a deposition chamber can range from approximately 1 mTorr to approximately 50 mTorr. Deposition rates can range from approximately 0.05 nm/s to approximately 50 nm/s. Oxygen partial pressures in the plasma can range from 0% (e.g., all argon and oxygen only from the target) to 100%.

The deposition techniques can be used with a wide variety of materials. Examples of metals that can be deposited to form a cermet include nickel, silver, platinum, copper, tungsten, gold, iridium, and ruthenium. More than one (e.g., two, three, four or more) metal can be included, in any combination, into the cermet. Examples of ceramic materials that can be deposited to form a cermet include those that include non-metals (e.g., oxides), such as yttria stabilized zirconia (YSZ), gadolinia doped ceria, ceria, hafnia, bismuth oxides, doped lanthanum silicates, doped lanthanum or barium cobaltites, ferrites, chromites, manganites, and zirconia and ceria with other dopants. More than one (e.g., two, three, four or more) ceramic material can be included, in any combination, into the cermet.

The composition of the resulting cermet can be controlled by the relative thickness of each layer. The concentration of the metal can range, for example, from approximately 10% to approximately 60%, with the balance being ceramic material.

In some embodiments, the composition of the cermet is varied along its thickness. For example, in anode 24, it may be desirable to increase the concentration of the ceramic material in the portion of the anode that is closest to and interfaces with electrolyte 28 to improve thermal matching as well as catalysis. More specifically, such a variation can provide more electronic conduction paths away from the electrolyte, where there is a higher electronic current, and more ionic conduction paths near the electrolyte, where there is higher ionic current, while keeping a large triple phase boundary in all regions to aid catalysis. Additionally or alternatively, the concentration of the metal in the portion of anode 24 that is farther away from electrolyte 28 and/or near the surface juxtaposed to interconnect 30 can be increased to facilitate catalysis and to reduce resistance for electrons. This variation in the composition of anode 24 can be achieved, for example, by modulating the deposition rate of the metal and/or the ceramic material, by changing the deposition time for each material, and/or by changing the thickness of each material. Along the thickness of anode 24, the concentrations of the metal and/or the ceramic material can vary, for example, linearly or non-linearly (e.g., step-wise).

The absolute thicknesses of the deposited materials can also be used to control the grain size in the cermet to some extent. For example, layers that are each approximately 5-15 nm thick can yield grains approximately 7-20 nm in diameter. Layers that are 5 nm thick can yield ˜7 nm grains, and layers that are 15 nm thick can yield ˜20 nm grains. The typical grain size is of the order of film thickness. In some embodiments, grain size can be slightly larger than layer thickness, which indicates that each layer, rather than forming a continuous film, breaks into disconnected grains that fill in the gaps from disconnected grains in the previous layer. Transmission or scanning electron microscopy can be used to image the grains. SEM and XRD can provide similar results for grain size, which suggests that generally the grains visible by SEM are single crystals.

The porosity of the cermet can be changed by controlling substrate temperature, gas pressure, and/or deposition rate, although these parameters can also affect grain size. The substrate temperature (as measured by a thermocouple near the substrate in the deposition chamber) can range from approximately 25° C. to approximately 600° C., and in some embodiments, higher temperatures increase porosity. Similarly, gas pressure can range from approximately 1 mTorr to approximately 75 mTorr, and higher gas pressures tend to increase porosity. The rates of deposition can range from approximately 0.1 nm/s to approximately 50 nm/s.

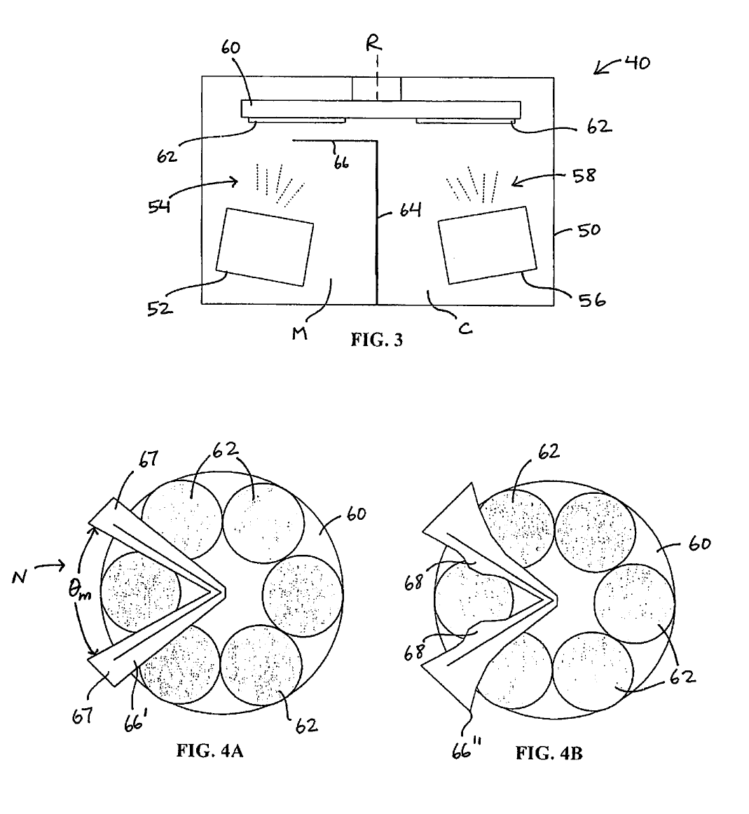

In some embodiments, forming the cermets includes moving the substrate on which the cermets are formed between a region of metal flux (and substantially no ceramic flux) and a region of ceramic flux (and substantially no metal flux). Referring to FIG. 3, a deposition system 40 includes a deposition chamber 50 containing a metal source 52 capable of providing metal flux 54, and a ceramic source 56 capable of providing ceramic flux 58. System 40 further includes a rotatable mounting plate 60 that carries one or more substrates 62 at the perimeter of the plate and is capable of rotating about axis R. Mounting plate 60 and sources 52, 56 are arranged so that fluxes 54, 58 can be delivered onto substrates 62 mounted on the mounting plate to form metal and ceramic layers.

System 40 further includes a partition 64 in deposition chamber 50 that separates sources 52, 56 and their fluxes into different regions M and C, respectively. When a substrate 62 is in region M, only metal flux 54 can be deposited on the substrate, and ceramic material is prevented from depositing onto the substrate. Similarly, when a substrate 62 is in region C, only ceramic flux 58 can be deposited on the substrate, and metal is prevented from depositing onto the substrate. Alternating layers of metal and ceramic material can be formed on substrates 62 by continuously providing fluxes 54, 58, slowly rotating mounting plate 60 about axis R, and moving substrates 62 repeatedly between region C and region M. As a substrate 62 moves through region M or region C, the substrate is exposed to metal flux 54 or ceramic flux 58 long enough to form a layer with the desired thickness, at which point the substrate is moved to the other region to form another layer on the previously-formed layer. In some embodiments, the first and/or the last deposited layer on all substrates 62 include either metal or ceramic material, for example, to enhance adhesion. These depositions can be performed by leaving one source shuttered and/or powered down at the beginning and/or at the end of the deposition process for one full rotation of mounting plate 60.

Forming the cermets by moving the substrate(s) can provide high-throughput and other advantages. For example, since multiple substrates 62 can be carried by mounting plate 60, the throughput can be high, and the waste can be low since the area on the mounting plate that is not covered by a substrate is small. Also, since fluxes 54, 58 are continuously provided during operation, cermets can be formed without needing to repeatedly shutter (i.e., open and close) sources 52, 56. Shuttering an active source wastes source material and power, and accelerates the maintenance schedule for shutter as material can build up and fall back into the source and/or cause electrical problems. This build-up problem can be particularly severe if one source deposits significantly faster than the other source, as can often be the case with metals (fast) and ceramics (slow). Furthermore, since sources 52, 56 can be active continuously, there is no need to turn the sources on to deposit a layer, off when the layer is deposited, and repeating this on-off cycle for each layer to be deposited. Frequent and/or rapid power cycles can damage sources 52, 56 and/or lead to variations in deposition rates from cycle to cycle.

Still referring FIG. 3, in some embodiments, partition 64 includes a mask 66 at its end closest to mounting plate 60. As shown, mask 66 is positioned between sources 52, 56 and substrates 62, or upstream of the substrates, relative to the flow of fluxes 54, 58 from the sources to the substrates. Mask 66 can be used when the materials to be deposited have different deposition rates and/or when deposition of a material may be non-uniform. For example, referring to FIG. 4A, different deposition rates can be compensated by exposing substrates 62 to the faster-depositing material (e.g., the metal) within the narrow area (N) defined by a wedge-shaped mask 66′ having connected portions 67 that diverge from the center of mounting plate 60. The slower-depositing material (e.g., the ceramic material) can be deposited on substrates 62 when the substrates are not in area N. In the example shown in FIG. 4A, wedge-shaped mask 66′ can be used when the faster-depositing material deposits approximately five times faster than the slower-depositing material. More generally, the angle to expose to the faster-depositing material can satisfy

$$\begin{matrix}Equation 1 & \\ {θ}_{m} = \frac{2 π}{\frac{{zY}_{m}}{{zY}_{c}} \frac{{x}_{i}}{{x}_{m}} + 1} & ( 1 )\end{matrix}$$

where zYi and xᵢ are the deposition rate and desired volume fraction of component i (as shown, “c” for ceramic, and “m” for metal). In some embodiments, the full circle of 2π is reduced due to the angular space covered by mask 66′.

Non-uniform depositions can also be corrected by changing the shape of mask 66, for example, as shown in FIG. 4B. Given arbitrary non-uniformity, this correction can be done numerically. First, the deposition rate is measured at every position zY (r,θ) by depositing a test film on a non-rotating substrate and measuring film thickness across the entire substrate. Next, a set of initial and final angles θ₀ and θₜ at every radius is numerically determined such that, at each radius, the same total thickness z(r) will be deposited, where:

z(r)=∫_{θ}_{₀}₍ᵣ₎^{θ}^{ₜ}^{(l)}zY(r,θ)lωdθ (2)

and ω is the rotation rate. The rotation rate ω has been included in Equation 2 so the units will be correct, but changing this rate (for example, to change the thickness of each layer) does not affect uniformity achieved this way. Referring to FIG. 4B, the result is a mask 66″ that includes bulges 68 extending or protruding inwardly toward each other in narrow region N to provide a smaller difference between θ₀ and θₜ at radii with the highest average deposition rates. Modulating the cermet composition in this framework can be done by changing the deposition rate of one or both sources. For example, continuous deposition (FIGS. 3, 4A and 4B) can be combined with composition modulation (where each individual layer has a different thickness, as described above) by altering the deposition rates of the sources during deposition. Also, without changing deposition rates, all layer thicknesses can be changed proportionally by altering the rotation rate.

Referring again to FIG. 2, in some embodiments, after the cermets are formed, they are annealed. Annealing provides grain growth and phase stabilization. Annealing can be performed at approximately 200° C. to approximately 600° C. for approximately 0.1 hr to approximately 10 hr. The cermets can be annealed in an inert atmosphere (such as nitrogen or argon) or in a reducing atmosphere (such as dilute hydrogen). In some embodiments, annealing causes some of the metal (e.g., nickel) to agglomerate on the surface of the cermet, although high electrical conductivity can suggest that there is a significant metal concentration in the bulk of the cermet.

After the cermets are formed, they can be formed into anode 24 according to conventional techniques. For example, a cermet can be grown onto an electrolyte layer.

Anode 24 can be used in a conventional solid oxide fuel cell. For example, electrolyte 28 can include doped zirconia (e.g., YSZ), and cathode 26 can include lanthanum strontium manganite. The fuel can include hydrogen and/or a hydrocarbon (such as methane and/or butane).

While a number of embodiments have been described, the present disclosure should not be read as being limited to these embodiments.

For example, the apparatuses and techniques described herein can be used to form a structure for use as cathode 26. Examples of cathode materials include lanthanum strontium manganite, lanthanum strontium cobaltite, and lanthanum strontium cobalt ferrite.

In some embodiments, the apparatuses and techniques described herein can be used to form a cermet that is subsequently etched (e.g., with an acid) to remove the metal(s), thereby providing a nano-porous ceramic structure that can be used as a cathode. The porosity of the ceramic structure can be high and tunable, and its pore size can be tunable.

In some embodiments, a cermet includes three or more components, e.g., a ceramic material, a first metal, and a second metal. One of the components (e.g., the second metal) can be selectively removed (e.g., etched without removing the first metal) to provide independent control of pore volume relative to the remaining components (e.g., the ceramic material and the first metal volumes).

As another example, rather than moving substrates by rotating a mounting plate, a substrate can be carried on a slidable plate that is translated between region M and region C to form the metal and ceramic layers.

As another example, co-sputtering (which is another physical vapor deposition technique) can yield a phase-separated cermet. By sputtering from two targets simultaneously, with varying deposition rates, it is possible to obtain a phase separated mixture of metal-ceramic composite.

The following examples are illustrative and not intended to be limiting.

### EXAMPLES

A Ni/YSZ cermet was formed by depositing multiple layers.

Yttria stabilized zirconia and nickel metal were sputtered at mom temperature to form a cermet. More specifically, five layers of YSZ (from a target of 8 mol % Y₂O₃ doped ZᵣO₂), each approximately 15 nm thick, and five layers of Ni (from a pure Ni target), each approximately 15 nm thick, were alternated and formed by sputtering. The chamber pressure was 5 milliTorr of argon, and the deposition rates were approximately 1 nm/min for YSZ and approximately 5 nm/min for Ni. Grain size and crystal phases were characterized by XRD and SEM.

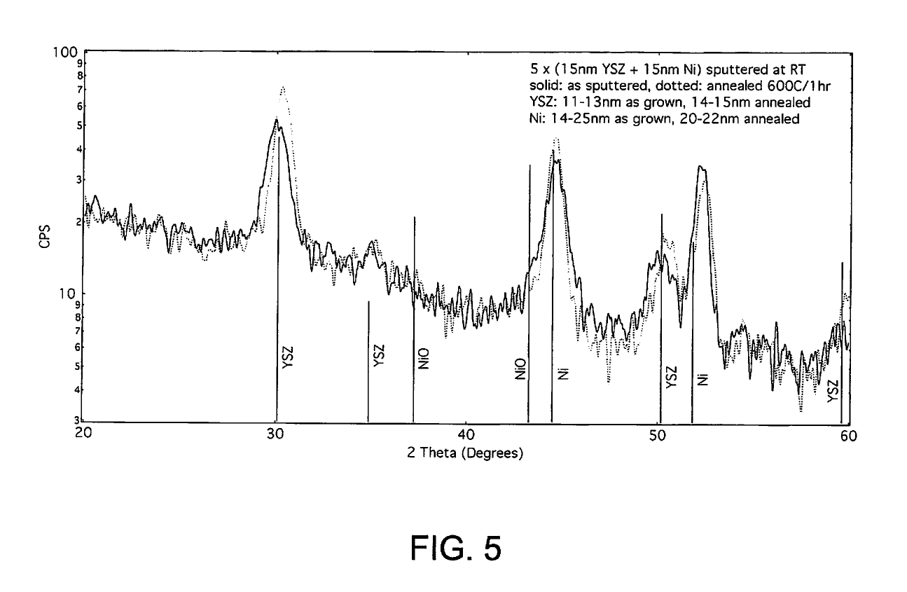

FIG. 5 shows X-ray diffraction patterns of cermet films, as deposited above and after one hour of annealing at 600° C. in 5% H₂ in argon. The X-ray diffraction data reveal only YSZ and Ni phases, with no apparent NiO or unidentified phases. The grain size, as determined by the Scherrer equation, was approximately 12-20 nm and grew slightly after annealing.

Grain sizes obtained from the SEM images are consistent with those obtained by X-ray diffraction. The SEM images also show some nickel agglomeration on the surface 10 of the cermet films upon annealing.

Still other embodiments are within the scope of the claims that follow this section.

It should be noted that various changes and modifications to the embodiments described herein will be apparent to those skilled in the art. Such changes and modifications may be made without departing from the spirit and scope of the present disclosure and without diminishing its attendant advantages.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

Nothing that has been stated or illustrated is intended to cause a dedication of any component, step, feature, object, benefit, advantage, or equivalent to the public.

What is claimed is:

1. A method of making a fuel cell electrode, comprising:
depositing alternating first and second layers on a substrate, the first layer comprising a metal, and the second layer comprising a non-metal.

2. The method of claim 1, further comprising moving the substrate between a first region containing the metal and substantially free of the non-metal, and a second region containing the non-metal and substantially free of the metal.

3. The method of claim 1, further comprising varying the composition of at least one of the metal and the non-metal along the thickness of the layers.

4. The method of claim 1, further comprising heating the deposited layers.

5. A method comprising:
creating an electrode by depositing alternating first and second layers on a substrate, the first layer comprising a metal, and the second layer comprising a non-metal; and
using the electrode to make a solid oxide fuel cell.

6. The method of claim 5, wherein the act of creating the electrode further comprises moving the substrate between a first region containing the metal and substantially free of the non-metal, and a second region containing the non-metal and substantially free of the metal.

7. The method of claim 6, wherein the act of creating the electrode further comprises delivering the metal and the non-metal to the substrate from a metal source and a non-metal source, respectively, and wherein at least one of the sources is not de-activated or shuttered when the substrate is moved between the first and second regions.

8. The method of claim 6, wherein the act of moving the substrate comprises moving the substrate on a rotatable carrier.

9. The method of claim 8, wherein the rotatable carrier is adapted to carry a plurality of substrates.

10. The method of claim 6, wherein the act of creating the electrode further comprises masking delivery of at least one of the metal and the non-metal, prior to depositing the layers on the substrate.

11. The method of claim 10, wherein the act of masking delivery comprises passing at least one of the metal and the non-metal through a mask having connected and diverging portions.

12. The method of claim 11, wherein the connected and diverging portions include inwardly facing protrusions.

13. The method of claim 5, wherein the layers are deposited using one of: physical vapor deposition and chemical vapor deposition.

14. The method of claim 5, wherein the act of creating the electrode further comprises varying the composition of at least one of the metal and the non-metal along the thickness of the layers.

15. The method of claim 5, wherein each one of the layers comprise a structure having grain sizes of about 7 nm to about 20 nm.

16. The method of claim 5, wherein the act of creating the electrode further comprises heating the deposited layers.

17. The method of claim 16, comprising heating the deposited layers at approximately 200° C. to approximately 600° C. for at least 0.1 hr.

18. The method of claim 16, comprising heating the deposited layers in a reducing atmosphere.

19. The method of claim 5, wherein each layer has a thickness of approximately 1 nm to approximately 500 nm.

20. The method of claim 5, wherein the metal comprises at least one of: nickel, platinum, silver, copper, tungsten, gold, iridium, and ruthenium.

21. The method of claim 5, wherein the second layer comprises a ceramic material, and wherein the ceramic material comprises at least one of ceria, hafnia, yttria stabilized zirconia, gadolinia doped ceria, bismuth oxide, doped lanthanum silicate, doped lanthanum cobaltite, doped barium cobaltite, ferrite, chromate, manganite, doped zirconia, and doped ceria.

22. The method of claim 5, wherein the electrode is an anode.

23. A fuel cell electrode, comprising:
a substrate; and
alternating first and second layers deposited on the substrate;
wherein the first layer comprises a metal, and the second layer comprises a non-metal.

24. The fuel cell electrode of claim 23,
wherein the substrate is movable between a first region containing the metal and substantially free of the non-metal, and a second region containing the non-metal and substantially free of the metal.

25. The fuel cell electrode of claim 23, wherein at least one of the metal and the non-metal has a composition that varies along the thickness of the layers.

26. The fuel cell electrode of claim 23, wherein each one of the layers comprises a structure having grain sizes of approximately 7 nm to approximately 20 nm.

27. The fuel cell electrode of claim 23, wherein the deposited layers comprise heated layers.

28. The fuel cell electrode of claim 23, wherein each layer has a thickness of approximately 1 nm to approximately 500 nm.

29. The fuel cell electrode of claim 23, wherein the metal comprises at least one of: nickel, platinum, silver, copper, tungsten, gold, iridium, and ruthenium.

30. The fuel cell electrode of claim 23, wherein the second layer comprises a ceramic material, and wherein the ceramic material comprises at least one of: ceria, hafnia, yttria stabilized zirconia, gadolinia doped ceria, bismuth oxide, doped lanthanum silicate, doped lanthanum cobaltite, doped barium cobaltite, ferrite, chromate, manganite, doped zirconia, and doped ceria.

31. A fuel cell comprising a fuel cell electrode;
wherein the fuel cell electrode includes alternating first and second layers on a substrate, the first layer comprising a metal, and the second layer comprising a non-metal.

32. The fuel cell of claim 31, wherein the fuel cell is a solid oxide fuel cell.
